(19) United States
(12) Patent Application Publication
(10) Pub. No.: US 2006/0047655 A1
(43) Pub. Date: Mar. 2, 2006

(54) Fast unsupervised clustering algorithm

(76) Inventor: William Peter, Bethesda, MD (US)

Correspondence Address: SWIDLER BERLIN LLP, 3000 K STREET, NW, BOX IP, WASHINGTON, DC, 20007, US

(21) Appl. No.: 11/209,645

(22) Filed: Aug. 24, 2005

Related U.S. Application Data
(60) Provisional application No. 60/603,910, filed on Aug. 24, 2004.

(51) Int. Cl. G06F 17/30

(52) U.S. Cl. 707/6

(57) ABSTRACT

A method for clustering large datasets in which a number N of data instances with a number n fields is linearly weighted to an n-dimensional mesh with (for example) m grid points per dimension, a number of “intelligent agents” is placed randomly on the mesh. These agents move along the grid according to special rules that cause them to find grid points that have the largest weight. All clusters can be determined in this fashion and the clusters can be ranked in “strength”, these maxima are then used as the “centroid” of each cluster. If desired, the mesh can be gridded finer around these “centroids” to obtain finer scaling, and all data points within a certain specified distance of these centroids are considered to form a cluster.

### CROSS REFERENCE TO RELATED APPLICATIONS

The present invention claims priority to U.S. provisional patent application No. 60/610,693 filed on Aug. 24, 2004.

### BACKGROUND OF THE INVENTION

1. Field of the Invention

The present invention relates to unsupervised clustering of large datasets. More particularly, the present invention relates to processes for unsupervised clustering of large datasets having various types of data, including geospatial data.

2. Brief Description of Prior Developments

Increased use of Geographical Information Systems (GIS) has resulted in large accumulations of spatially-referenced database information, as is disclosed in V. Estivill-Castro and M. E. Houle, “Robust Distance-Based Clustering with Applications to Spatial Data Mining,” Algorithmica, 20(2):216-242,2001. Spatially-referenced datasets are now being generated faster than they can be meaningfully analyzed, as is disclosed in S. Aronoff, “Geographic Information Systems: A Management Perspective,” WWDL Publications, Ottawa, Canada, third edition, 1993. For example, the NASA Earth Observing System, as is disclosed in Goddard Space Flight Center. NASA's Earth Observing System at http://eospso.gsfc.nasa.gov. will deliver close to a terabyte of remote sensing data per day. NASA estimates that this coordinated series of satellites will generate petabytes of archived data in the next few years, as is disclosed in A. Zomaya, T. El=Ghazawi, and O. Frieder, “Parallel and distributed computing for data mining,” IEEE Concurrency, 7,(4), 1999.

Central to the problem of spatial data mining is clustering, as disclosed in R. T. Ng and J. Han, “Efficient and Effective Clustering Methods for Spatial Data Mining, J. Bocca, M. Jarke, and C. Zaniolo, editors, Proceedings of the 20^{th} Conference on Very Large Data Base (VLDB) pages 144-155, Morgan Kaufmann Publishers, San Francisco Calif., June 1994, which has been identified as one of the fundamental problems in the area of knowledge discovery in databases.

Most existing clustering algorithms require multiple data scans to achieve convergence as is disclosed in P. S. Bradley, U. Fayyad, and C. Reina, “Scaling Clustering Algorithms to Large Databases” Proceedings of the Fourth International Conference on Knowledge Discovery and Data Mining, KDD-1998, pages 9-15, New York, N.Y., August 1998, AAAI Press, and many are sensitive to initial conditions and are then trapped at local minima. Algorithms to cluster spatial data have usually been based on standard hierarchical methods such as: Ward's algorithm as disclosed in J. H. Ward, “Hierarchical grouping to optimize an objective function”, Journal of the American Statistical Association, 58(2):236-244, 1963; partitioning techniques like the K-means heuristic as disclosed in J. A. Hartigan and M. A. Wong, “A k-means clustering algorithm”, Applied Statistics, 28:100-108, 1979; or density-based methods as disclosed in A. Hinneburg and D. A. Keim, “An Efficient Approach to clustering in Multimedia Databases with Noise”, In Proc. 4^{th} Int. Conf. On Knowledge Discovery and Data Mining. AAAI Press, 1998.

Hierarchical clustering methods as disclosed in: F. Murtagh, “Commentsa of parallel algorithms for hierarchical clustering and cluster validity”, IEEE Transactions on pattern Analysis and Machine Intelligence, 14(10):1056-1057, November 1992; and J. H. Ward, “Hierarchical grouping to optimize an objective function”, Journal of the American Statistical Association, 58(2):236-244, 1963; and the K-medoid partitioning method as disclosed in J. Hershberger and S. Suri, “Finding Tailored Partitions”, Journal of Algorithms, 12(4):431-463, 1991; and R. T. Ng and J. Han. “Efficient and Effective Clustering Methods for Spatial Data Mining, J. Bocca, M. Jarke, and C. Zaniolo, editors, Proceedings of the 20^{th} Conference on Very Large Data Base (VLDB) pages 144-155. Morgan Kaufmann Publishers, San Francisco Calif., June 1994 have an unacceptably large computational cost of O(N²). A less costly alternative is the classic K-means algorithm which is O(N) (for each iteration). Because many of these methods cannot a priori determine the number of clusters in a dataset, they have limited real applicability. For K-means the results are strongly dependent on the initial (random) choice of cluster representative, and thus not unique. Furthermore, many of these algorithms do not cluster directly on density, but on criteria such as merging cost, which for the least-squares criterion tends to overemphasize roughly equal cluster size as is disclosed in W. S. Sarle, “Cluster Analysis By Least Squares”, Proceedings of the Seventh Annual SAS Users Group International Conference, pages 651-653, 1982.

In the density-based approach of DENCLUE, as is disclosed in A. Hinneburg and D. A. Keim, “An Efficient Approach to clustering in Multimedia Databases with Noise”, Proc. 4^{th} Int. Conf. On Knowledge Discovery and Data Mining, AAAI Press, 1998, a so-called influence function is applied to each data point of a dataset. The overall density function of the data space (whose local maxima are identified as density attractors or cluster centers) is the sum of the influence functions of each data point. DENCLUE is fundamentally O(N log N), although in practice the efficiency is better if the distribution of data is suitably localized.

Clustering often relies on calculating distances between pairs of N data points in a multi-dimensional space. Such calculations are similar to the calculation of the force between N particles separated by a given distance. During the past 50 years, physicists have struggled with reducing the computational time of these so-called N-body problems. The computational cost of N-body interactions is O(N²) since every particle's interaction with the other N-1 particles is calculated, and this is done for each of the N particles.

One approach to reducing computational time on N-body are the so called particle-mesh methods as disclosed in M. J. A. Berry and G. Linoff, “Data Mining Techniques—for Marketing, Sales and Customer Support,” John Wiley & Sons, New York, 1997. In this case, the dataset (which is assumed to have N points in an n-dimensional space) are weighted to the grid points of a mesh by some suitable weighting scheme. In this way, information of particle density and velocity is transferred to the mesh. Since the number of grid points is usually far less than that of the number of total particles, significant savings in computational times are achieved. Particle-mesh methods have made many problems in plasma physics and fluid dynamics amenable to computer simulations as disclosed in R. W. Hockney and J. W. Eastwood, “Computer Simulation Using Particles,” Adam Hilger, Bristol and New York, 1988, and in C. K. Birdsall and A. B. Langdon, “Plasma Physics via Computer Simulation,” Adam Hilger, Bristol, 1991.

### SUMMARY OF INVENTION

According to the present invention, an algorithm provides a new way of clustering data in an unsupervised manner. This algorithm is fast, efficient, and robust, and is ideal for large datasets. It consists of the following steps: (1) A number N of data instances with a number n fields is linearly weighted to an n-dimensional mesh with (for example) m grid points per dimension. (2) A number of “intelligent agents” is placed randomly on the mesh. These agents move along the grid according to special rules that cause them to find grid points that have the largest weight. All clusters can be determined in this fashion and the clusters can be ranked in “strength”. (3) These maxima are then used as the “centroid” of each cluster. If desired, the mesh can be gridded finer around these “centroids” to obtain finer scaling. (4) All data points within a certain specified distance of these centroids are considered to form a cluster.

It costs ˜O(N) computations to weight N data points to an n-dimensional mesh. If there are m grid points per dimension it costs m log m computations to sort for those mesh points for the larges density. Note that in general m N, so that the computational cost of the method is approximately O(N+m log m)˜O(N). This effectively reduces large datasets (e.g., N>10⁹—i.e., terabytes and larger) to a very manageable size.

Clusters can also be ranked according to strength, which is an important advantage over other clustering algorithms. In addition, the algorithm is ideally suited for distributed or massively parallel computations, and for incremental clustering (1) A number N of data instances with a number n fields is linearly weighted to an n-dimensional mesh with (for example) m grid points per dimension. (2) A number of “intelligent agents” is placed randomly on the mesh. These agents move along the grid according to special rules that cause them to find grid points that have the largest weight. All clusters can be determined in this fashion and the clusters can be ranked in “strength”. (3) These maxima are then used as the “centroid” of each cluster. If desired, the mesh can be gridded finer around these “centroids” to obtain finer scaling. (4) All data points within a certain specified distance of these centroids are considered to form a cluster.

In this paper, we present a new algorithm that has been developed to cluster large volumes of data automatically and without supervision. This algorithm is fast and accurate, and can quickly find locations of high data densities (i.e., clusters) and rank them accordingly. It can also be used in a real-time, and incremental mode, so new data can be dynamically clustered without re-clustering old data.

Important advantages of the present invention are (1) speed, (2) all clusters can be determined automatically, and without supervision, (3) clusters can be ranked by density, (4) new data can be clustered incrementally, and (5) the clustering is amenable to massively parallel or distributed computation.

### BRIEF DESCRIPTION OF THE DRAWINGS

The present invention is further described with reference to the accompanying drawings wherein:

FIG. 1 is a drawing showing data weighting to nearest grid points on a pone-dimensional mesh wherein in nearest grid point weighting, the data point at xᵢ is assigned to the nearest grid point at xₚ and in linear weighting, the data point at xᵢ is shared between xₚ and xₚ₊₁ according to linear interpolation;

FIG. 2 is a plot showing the simple two-dimensional example dataset. Wherein three clusters can be seen with centers near (4,4), (−4,4) and (4,−4);

FIG. 3 is a drawing showing a contour plot of the data in FIG. 2 weighted to a coarse 9×9 grid wherein the three clusters are clearly seen; and

FIG. 4 is a plot showing the large spatial dataset (˜10^{5 data points) distributed between latitudes} 37° and 46°, and longitudes 169° and 180°.

### DETAILED DESCRIPTION OF THE PREFERRED EMBODIMENT

The ACE Algorithm

In this section, the ACE algorithm is described, which, based on clustering data using a particle-mesh heuristic and rule-based agents, determines (and ranks) grid points associated with the highest data density.

1. Grid Weighting

Consider a database for which each of the N data items in the database has a number n of associated fields (or “features”). Then each data item can be represented by a point in an n-dimensional real space. In this n-dimensional region occupied by the data, it is possible to impose a coordinate system with axes whose minimum and maximum values correspond to the minimum and maximum values of the data.

Note that this mesh does not need to be uniform throughout space, and in some cases it is even desirable to impose a nonuniform grid on the region of interest. For example, in the case geospatial data, it might be useful to define a grid where regions of interest (e.g., forests) are finely-zoned, and less interesting regions (e.g., bodies of water) are coarsely-zoned. Consider the problem in one spatial dimension x with a uniform grid of cell spacing H. Generalization to higher n dimensions is straightforward.

At each grid point xₚ on the mesh, we will define a density of data p(xₚ) which is obtained by “weighting” the raw data values to grid points. For a given weighting function W(xᵢ−xₚ), the density at a grid point xₚ due to N data points at positions xᵢ is given formally in one-dimension by:

$$ρ ( {x}_{p} ) = \frac{1}{H} {\sum }_{i = 1}^{N} W ( {x}_{i} - {x}_{p} )$$

The “weighting” algorithm is simply a method of assigning spatial information of data points to nearby grid point on the mesh. For example, to zero order, we can weight the data simply by assigning the positions to the nearest grid points. By this prescription, if there are no data points close to a grid point xₚ then p(xₚ) 0. Similarly, if there are 15 data points that are closest to xₚ, then p(xₚ)=15 (in arbitrary units of the inverse cell length 1/H). This zero-order weighting, or nearest grid point weighting corresponds to the zeroth order term in a series expansion of W(x−xₚ) about the smallness parameter (x−xₚ). C. K. Birdsall and A. B. Langdon, “Plasma Physics via Computer Simulation,” Adam Hilger, Bristol, 1991.

To next order in the interpolating each data point to neighboring grid points. The first-order weighting prescription can be written formally as:

$$W ( x - {x}_{p} ) = \{ \begin{matrix}1 - \frac{\vert x - {x}_{p} \vert}{H} & if \vert x - {x}_{p} \vert \leq H \\ 0 & otherwise\end{matrix}$$

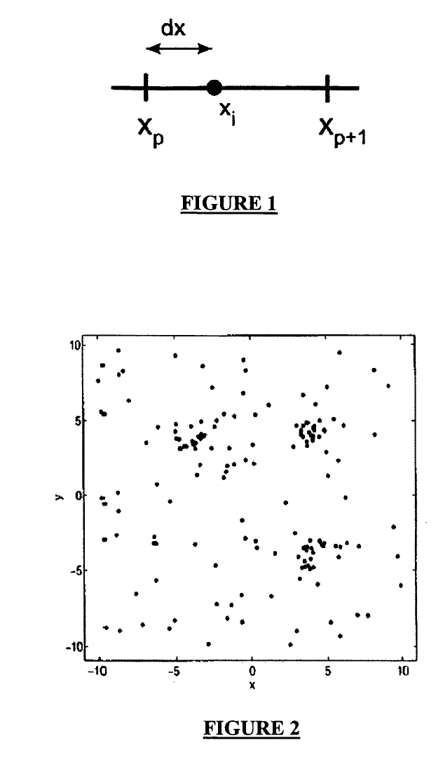

Higher orders are similarly obtained. In FIG. 1, a given data point at xᵢ is shown between two grid points xₚ and xₚ₊₁. In nearest grid point weighting, the data at xᵢ is assigned to the nearest grid point at xₚ. In this case, the one-dimensional density P(xₚ) is increased in value by 1/H, where H is the cell size. In linear weighting the data at xᵢ is shared between xₚ and xₚ₊₁ in relation to its proximity to each grid point. If dx=xᵢ−xₚ, then p(xₚ) increases by (1−dx/H)(1/H) and p(xₚ₊₁) increases by (dx/H)(1/H).

2. Rule-Based Agents

Once the data densities are calculated at each grid point of the mesh by Eqs. (1-3), high-density p(xₚ) locations can be ranked by a sorting algorithm. Cluster ranking by sorting is computationally intensive for higher-dimensional data, so we choose to search for the high-density clusters by using a rule-based agent method. In this technique, a small number of agents are randomly placed on grid points of the mesh. The number of agents can be a fraction of the number of total grid points N₂. The goal of each agent is to climb the hills of data density. Each agent is given two “rules” of behavior, and is allowed a prescribed number of Nₛ of steps to achieve the goal. A typical value for Nₛ would be the number of steps it would take an agent to traverse a “diagonal” across the data space. The two rules of behavior are as follows:

Consider a one-dimensional grid (higher dimensions are easily generalized). At each step, (1) an agent residing at a grid point xₚ rolls a die to determine if it should move up to xₚ₊₁ or down to xₚ₋₁. In n-dimensions, this would be a 2n-sided die. (2) If it is found that the gent should move up a grid point, the agent moves to xₚ₊₁ only if it is moving up in density. That is, it only moves from xₚ to xₚ₊₁ if the density p(xₚ₊₁≧p(xₚ). In this way, after Nₛ steps, the agents should find themselves at places of density maxima.

The optimal number of agents to deposit on the mesh is a tradeoff between speed and accuracy. There should be little performance penalty in placing them on every grid point for low-dimensional problems. Topologically, if agents are not placed at every grid point, there could conceivably be some “data mountains” that would only be accessible via small “data hills”. These hills would act as local maxima “traps” since agents will not descend the hill to climb a nearby bigger mountain. If only a small number of agents are initialized on the mesh (say, one agent for each ten grid points), we have found that one or two random restarts of the agent population are sufficient to locate the relevant grid points associated with density maxima.

3. Identification of Cluster Members

Once the positions of maximum density p(xₚ) are determined, it is useful to identify which data points are associated with each hub xₚ. This usually involves some domain knowledge such as (for example) setting appropriate threshold values based on distance from the hub. The choice of mesh to impose also involves some domain knowledge, since for optimal results, the cell length H should be chosen to have a value less than the smallest expected cluster size. This allows the grid to “resolve” the size of the cluster. In cases where the cluster size is unknown, or varies significantly over parameter space, ACE includes an additional iterative step to more accurately associate cluster members with associated hubs.

3.1 Cell and Distance Methods

Consider a particular grid point xₚ that has been tagged by the rule-based agents as associated with a high data density. Data points within a user-specified distance threshold Δ can be assumed to belong to the cluster with hub at xₚ. If the cells surrounding xₚ have cell size H<Δ, this is simply done by identifying those data points lying within an integral number of the Δ/H nearest-neighbor cells.

In the case for which cluster size is unknown (or, equivalently, the grid spacing is not suitably chosen), additional iterations are appropriate. For example, two neighboring high-density grid points might suggest that the cell size is too fine. In such a case, ace associates the members of the lower-density hub with that of its higher-density neighbor (although more sophisticated iterations are obviously possible). Conversely, if p(xₚ₋₁)<<p(xₚ) for a nearest-neighbor grid point p−1, the grid spacing might be too large. In that case, the mesh around xₚ can be rezoned more finely in order to confirm cluster quality.

The position of the hub at xₚ can also be iteratively recalculated to be the cluster centroid:

$$\overline{x} = \frac{1}{{N}_{p}} {\sum }_{i = 1}^{{N}_{p}} {x}_{i}$$

xᵢ are the positions of the cluster members and Nₚ is their total number. With the hub now at the data centroid, data points within a distance Δ of (and not xₚ) would belong to this cluster.

3.2 Contouring Density Method

This technique involves forming cluster boundaries defined by the contours of p(x) having a density equal to a specified threshold value. It is implemented in one-dimension as follows: Given the values of p(xₚ) at every hub xₚ, form “cluster boundaries” by interpolating between xₚ and each of the nearest-neighbor grid locations (xₚ₋₁ and xₚ₊₁) to find the locations x such that p(x)=p_{thres on the mesh. For example, the threshold density could be (}1/e) of the value of the hub density p(xₚ), so pₜₕᵣₑₛ=p(xₚ)/e. Then all data near xₚ lying inside the pₜₕᵣₑₛ contours would be members of the cluster at xₚ. If the density at a neighboring grid point (say, xₚ₊₁) satisfies xₚ₊₁>pₜₕᵣₑₛ, it will be necessary to interpolate between xₚ and xₚ₊₂ to find the cluster boundary, etc. In more than one dimension, contouring can be done by the usual method as disclosed in “Open Channel Foundation Contour Plot Algorithm” at http://www.openchannelfoundation.org/, NASA Case ARC-11441.

4. Computational Complexity

The number of computations for the algorithm is O(N+N_{g} log N_{g}), where N is the number of data items and N_{g} is the number of grid points in the mesh. For large datasets, N>>N_{g}, so the number of computations is ˜O(N).

### SMALL DATASET EXAMPLE

As a simple demonstration of the ACE algorithm, consider a small simulated dataset of 160 points P(s,y) in two-dimensions. The data consisted of one hundred of points randomly distributed in the interval between −10<x<10 and −10<y<10. In addition, as shown in FIG. 2, three artificial clusters of points (20 points in each cluster) were produced that were randomly distributed around the positions (4,4), (−4,4) and (4,−4).

This particular small dataset (N˜N_{g}) example was chosen to gauge the effectiveness of ACE in identifying data clusters immersed in a background of noisy data (FIG. 2). The mesh used for the example dataset was a two-dimensional grid only nine cells (ten grid points) wide in each dimension. In the region between −10<x<10 and −10<y<10, this corresponded to a uniform cell size of Hₓ=H_{y}=2.2.

5. Results with ACE

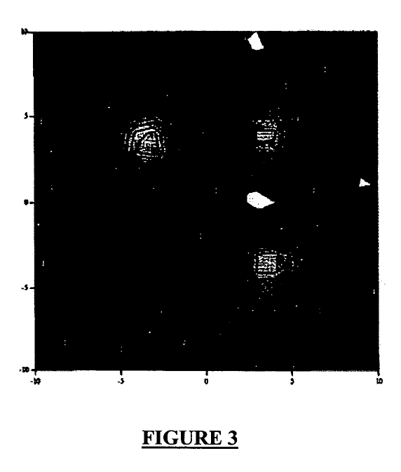

The ACE algorithm was run on this small example dataset. Output of the code was a list of the final positions P(xₚ, Yₚ) of each agent ranked by the associated data density p(xₚ, Yₚ). In addition, a contour plot of p(x,y) is shown in FIG. 3 providing a good visualization of the high-density data regions.

TABLE 1
Cluster Ranking with Coarse-Zoned Mesh

| Agent Position | P(x, y)HₓH_{y} | Comments |
|---|---|---|
| (−3.3, 3.3) | 12.7 | Cluster near (−4, 4) |
| (3.3, −3.3) | 10.8 | Cluster near (4, −4) |
| (3.3, 3.3) | 10.5 | Cluster near (4, 4) |
| (−1.1, −7.8) | 2.6 | Statistical background |
| (10.0, 7.8) | 2.2 | Statistical background |
| (−10.0, −1.1) | 2.1 | Statistical background |
| (−5.5, −3.3) | 1.8 | Statistical background |
| (7.8, −7.8) | 1.5 | Statistical background |

In Table 1 if is shown that the first 8 of 11 total rankings of p(x,y) as found by the rule-based agents. The top three items in the table represent the three clusters that were artificially placed in the dataset. These data peaks are at grid points corresponding to the coordinates (−3.3, 3.3), (3.3, −3.3), and (3.3, 3.3). If the zoning would have been finer, then the agent positions would have been closer to the exact values at (−4,4), (4,−4) and (4,4).

The remaining data peaks in Table 1 had values of p(x,y) roughly 1/10 the magnitude of the first three clusters. These peaks are statistical, and not meaningful, as can be easily shown: The region over which the data was defined had N_{g}˜10×10=100 total grid points, and the number of total data points was N=160. Then statistically, each grid point should have an average data values p(x,y) HₓH_{y}˜N_{g}/N˜1.6. As seen in Table 1, all but the first three clusters have data values near this statistical background value.

6. Comparisons With Other Methods

In this section, ACE is compared with a representative set of other clustering techniques. These comparisons cannot be claimed to be either rigorous or exhaustive, but are useful for outlining the general characteristics of each algorithm. They are indicative of both the qualitative differences and computational speed that can be expected.

TABLE 2
Small Dataset Clustering Times

| Algorithm | Run time (secs) | Cluster Identification |
|---|---|---|
| ACE | 0.005 | distinct |
| Autoclass | 7.148 | distinct |
| Ward | 0.006 | — |
| K-means 7.0 | 0.02 | — |
| TwoStep 7.0 | 0.03 | approximate |

The results are summarized in Table 2. For each of the five cases, a set of six clustering trials using the small dataset were done. The average run time for each case is shown in Table 2. In addition to timing statistics, the last column of Table 2 outlines how successful each algorithm was in finding the three artificial clusters. As discussed above, ACE was able to find all three clusters in the small example dataset of 160 points (FIG. 2).

The only other algorithm to have identified the three dense data regions as distinct clusters was NASA's Autoclass as is disclosed in P. Chessman, J. Kelly, M. Self, J. Stutz, W. Taylor, and D. Freeman, “Autoclass: A Bayesian classification system”, in J. W. Shavlik and T. G. Dietterich, editors, Readings in Machine Learning, pages 296-306, Kaufmann, San Mateo, Calif. 1990. Autoclass is an unsupervised algorithm based on Bayesian techniques for the automatic classification of data. When applied to the small example dataset of 160 points, Autoclass discovered 6 clusters, three of which represented the artificial clusters shown in FIG. 2. Unfortunately, Autoclass converges slowly to a solution, as discussed below.

K-means and Ward's minimum variance method tend to find clusters with roughly the same number of observations in each cluster as is disclosed in W. S. Sarle, “Cluster analysis by least squares”, in Proceedings of the Seventh Annual SAS Users Group International Conference, pages 651-653, 1982. Furthermore, they cannot a priori determine the number of clusters in the dataset. The Ward's algorithm as is disclosed in J. H. Ward, “Hierarchical grouping to optimize an objective function,” Journal of the American Statistical Association, 58(2):236-244, 1963 and its particular implementation came from Carnegie Mellon University's Statlib as is disclosed in Carnegie Mellon University. Statlib: Data, Software and News from the Statistics Community. http://lib.stat.cmu.edu/indes.php. Being a hierarchical algorithm, it provided results in the form of a dendrogram which (like all dendrograms) is difficult to summarize. Therefore, no comments were listed in the last column of Table 2. It is included for run-time comparisons only.

The K-means algorithm (founded in the commercial data mining package Clementine 7.0 as is disclosed SPSS, “Introduction to Clementine,” Chicago, Ill., USA, March 2002 depends on the initialization of the cluster representative, and on the chosen value of k. Accordingly, the cluster identification column in Table 2 (like that for Ward's) was left empty. Even when the number of clusters was set to k=3, the similarity between the three dense clusters of FIG. 2 and the three resulting K-means clusters was rather marginal.

The TwoStep algorithm from Clementine 7.0 found five diffuse clusters, all roughly equal in size. Three of these large clusters seemed to contain the three clusters shown in FIG. 2 as approximate “subsets”. The TwoStep algorithm is similar to the Birch clustering method as is disclosed in T. Zhang, R. Ramakrishnan, and M. Livny, “Birch: An Efficient Data Clustering Method for Very Large Databases”, in Proceedings of the 1996ACMSIGKDD international conference on Management of Data, pages 103-114, ACM Press, June 1996, in that it scans the entire dataset and stores the dense regions of data in terms of summary statistics. It then uses a hierarchical clustering algorithm to cluster the dense data regions. It differs from Birch in that it also includes a technique to automatically determine the appropriate number of clusters.

6.1 Run Time Comparisons

As discussed above, ACE runs were done by gridding up the dataset as shown in FIG. 2. Agents were placed at every grid point, which tended to penalize the run time, and each agent was allowed a maximum of Nₛ, calculated from the necessary number of steps it would take to traverse the grid. For an agent to traverse the grid along its diagonal with 10 grid points in each direction, Nₛ˜10\sqrt{2}.

As shown in Table 2, ACE clustered the data in only 0.005 seconds, similar to the Ward algorithm J. H. Ward, “Hierarchical Grouping to Optimize an Objective Function,” Journal of the American Statistical Association, 58(2):236-244, 1963 (0.006 sec), but significantly faster than the K-means (0.02 sec) and Two Step (0.03 sec) algorithms in SPSS, Introduction to Clementine. Chicago, Ill., USA, March 2002. The Bayesian clusterer Autoclass P. Chessman, J. Kelly, M. Self, J. Stutz, W. Taylor, and D. Freeman, “Autoclass: A Bayesian classification system,” J. W. Shavlik and T. G. Dietterich, editors, Readings in Machine Learning, pages 296-306, Kaufmann, San Mateo, Calif. 1990 was the slowest at 7.148 sec. The speed of ACE in the parameter regime N˜N_{g} is satisfying, since its performance relative to other method improves as N>>N_{g}.

### LARGE DATASET EXAMPLE

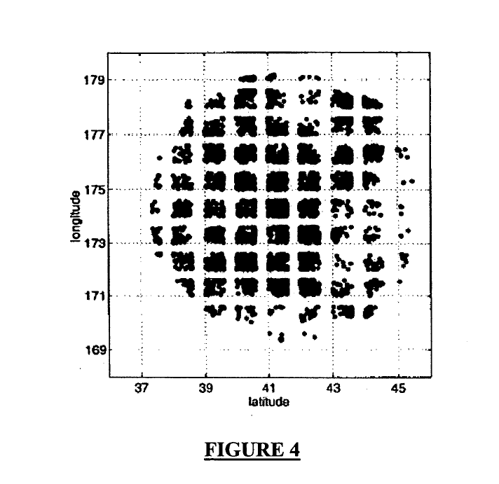

To test our method for clustering a large volume of data, we used a geospatial dataset made up of 10⁵ points with coordinates in latitude and longitude format. The data points are shown in FIG. 4 For the ACE runs, a coarse-zoning mesh with 21 cells (22 grid points) in both the x- and y-direction was initially used, as shown in the figure. This corresponds to a total number of grid points N_{g}=484, so N>>N_{g}. A close look at the data in FIG. 4 suggests that the number of clusters is ˜70.

Experiments with different sized meshes for ACE were performed on the large dataset to simulate the case when cluster size is unknown. The coarse-zoned mesh with 21 cells in either dimension initially found only 34 clusters. A fine-zoned iteration with a mesh of 31 cells per dimension (32 grid points), found 72 clusters. When the mesh was very finely-zoned (50 cells in each direction), 120 clusters were initially found. Since there were agents on neighboring grid points an automatic iteration was generated to “clean” the extraneous agents (Section 2.3) to 73 clusters. The number of steps each agent was allowed was fixed at Nₛ=500 for all cases. This was far above the minimum value required for the fine-zoned case of 51 grid points, Nₛ=51 \sqrt{2}. In all cases, run times for ACE were ˜1 sec. Again, because of the low dimensionality of the data (n=2), agents were initially placed on every grid point. This slightly penalizes the run-time results.

TABLE 3
Large Dataset Clustering Times

| Algorithm | Run time (secs) | Cluster Identification |
|---|---|---|
| ACE | 0.83 | Found 72 clusters |
| Autoclass | — | Could not converge |
| Ward | — | Could not initialize |
| TwoStep 7.0 | 2.25 | Found only 4 clusters |
| K-means 7.0 | 1.27 | — |

Table 3 shows a summary of the runs. Note that two of the algorithms were unable to handle the large dataset. NASA's Autoclass tried to converge to a solution for over 20 hours, before finally expiring. Ward's algorithm as is disclosed in J. H. Ward, “Hierarchical grouping to optimize an objective function”, Journal of the American Statistical Association, 58(2):236-244, 1963 (from Statlib as is disclosed in Carnegie Mellon University. Statlib: Data, Software and News from the Statistics Community) tried in vain to initialize a static array (used for dissimilarity measure) of dimension N(N−1)/2. Since N˜10⁵, the array was too large for initialization. The entry for IACEI corresponded to the case with 31 cells in each dimension. The run-time was on the average 0.83 seconds.

The only other algorithms which could successfully complete the data clustering (K-means and TwoStep from Clementine 7.0) had average run times of 1.27 and 2.25 seconds, respectively. These algorithms, however, could not obtain the correct number (˜70) of clusters. Even when the number of clusters was explicitly set to 70, the resulting clusters were of poor quality. When TwoStep was allowed to find the most suitable number k of clusters between k=2 and k=75, it determined that there were only four clusters in the data shown in FIG. 4

7. Other Considerations

In this section we discuss additional advantages of the ACE algorithm.

7.1 Parallel and Distributed Computation

ACE is ideal for running in a massively-parallel mode, or by distributed computation. Load balancing is achieved by dividing the spatial mesh into sectors, so that each processor only acts on a certain well-defined region of space. For efficiency, each sector might contain a roughly equal number of grids on the physical mesh (unless there is an anisotropy in the data which would preferentially require more processing power in certain spatial domains). Cluster which span sectors would be handled transparently by interprocessor communication between nodes.

7.2 Real-Time and Incremental Clustering

Unlike some algorithms for which any accumulation of new data require a complete-re-clustering, ACE can cluster new data incrementally. The method can be described as follows (we assume for simplicity one-dimensionality, but the argument is easily generalized to higher dimensions):

With the arrival of a new data point at location x, its position determines the mesh cell into which it is deposited. For example, if the magnitude of x satisfies xₖ<x<xₖ₊₁ then the data point is apportioned to the nearest grid points xₖ and xₖ₊₁ by linear weighting. SO p(xₖ) and p(xₖ₊₁) increase by an amount given by Eq. (1). Hence the effect of a new data point is simply to update the density at the nearest-neighbor grid points.

After a suitably large number of new data points are weighted to the grid, it is necessary to release a given number oft rule-based agents to check for changes in cluster rankings.

8. Conclusion

The methodology of ACE emphasizes the unsupervised identification of dense regions of collected data, i.e. clusters. It relies on imposing a mesh on the n-dimensional region in Rⁿ over which the N data points (with n features) are defined, and using an appropriate algorithm to weight the data to the grid. In most cases, linear weighting is sufficient, although for some special cases, higher order weighting can be used. Once the density p(xₚ) at each grid point xₚ on the mesh is known, the values at every xₚ can be ranked to give the most relevant cluster locations. The high density locations on the grid can be quickly obtained by instantiating a small number of rule-based agents randomly on the grid. These agents are then allowed to more uphill in a certain amount of time (steps).

Like the density-based method of DENCLUE as is disclosed in Carnegie Mellon University. Statlib: Data, Software and News from the Statistics Community, a cluster in ACE is defined solely by a high density of points. Unlike DENCLUE (whose cost is at worst ˜O(N log N)), ACE maps a set of N data points to a mesh with Ng grid points (in each dimension), resulting in a cost O(N) (for N_{g}<<N). In addition, while DENCLUE uses a hill-climbing algorithm based on the local density function and its gradient, the agent-based approach of ACE does not require the use of continuous and differentiable influence functions. Moreover, the agent-based technique allows for a simple (yet efficient) method to scan the data space for high-density peaks.

In summary, the work presented here has demonstrated significant possibilities to efficiently cluster large volumes of multidimensional geospatial data with a cost ˜O(N). It is essentially reduces the size of a dataset to the size of the grid over which the data is defined. It was shown to be accurate and fast for both a small (˜160 data points) example dataset, and for a large (˜10⁵ points) dataset. Because clusters are ranked by density, clusters made up of low-density noisy data can be identified (and ignored). Finally, the algorithm is ideally suited to incremental clustering and massively parallel or distributed computation. The algorithm may be implemented in computer software that is stored in any medium, including a hard disk drive, a network, a CD ROM drive or any other type of storage medium and that includes computer program instructions that cause the computer to carry out operational steps to determine clusters within one or more datasets.

While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for clustering large datasets comprising the steps of:
(a) designating a number N of data instances with a number n fields is linearly weighted to an n-dimensional mesh with m grid points per dimension;
(b) placing a number of intelligent agents randomly on the mesh wherein said agents move along the grid so that said agents are caused to find grid points having the largest weight;
(c) using said grid points having the largest weight as a centroid of each cluster;
(d) considering all data points within a certain specified distance of said centroids to form a cluster.

2. The method of claim 1 wherein a plurality of clusters are determined and said clusters are ranked in strength.

3. The method of claim 1 wherein the mesh is gridded more finely around the centroids to obtain finer scaling.

4. A method of clustering at least one dataset, the dataset including N points and at n fields, comprising:
(a) forming a n-dimensional grid;
(b) “weighting” each of the “N” data instances to the grid;
(c) determining at least one cluster within the data points bases on the weighting of points on the grid.

5. The method according to claim 4, wherein the grid has a uniform spacing.

6. The method according to claim 4, wherein the grid has a non-uniform spacing.

7. The method of claim 4, further comprising:
implementing a sorting algorithm to rank grid points by the magnitude of their associated weights; and
determining the centroids of clusters based on the sorting.

8. The method according to claim 4, further comprising repeating the method based by forming the grid with a finer spacing to more accurately determine the clusters.

9. The method of claim 7, where the sorting algorithm includes:
placing a number of agents on each grid point of the grid;
applying rules for these agents to move on the grid in steps; and
determining grid points with the highest associated value based on the position of each of the agents after at least one step.

10. The method of claim 9, wherein the agents are placed randomly on the grid.

11. The method of claim 9, wherein the agents are placed at predetermined positions on the grid.

12. The method according to claim 9, wherein the agents are initially place on the grid and additional agents are placed randomly on the grid.

13. The method according to claim 9, further comprising determining how many agents to place on the grid.

14. A computer program having computer program logic stored therein for causing a computer to identify clusters in at least one dataset, the dataset including N points and at n fields, comprising:
(a) forming logic for causing the computer to form a n-dimensional grid;
(b) weighting logic for causing the computer to weight each of the “N” data instances to the grid; and
(c) determining logic for causing the computer to determine at least one cluster within the data points bases on the weighting of points on the grid.

15. The computer program product according to claim 14, wherein the grid has a uniform spacing.

16. The computer program product according to claim 14, wherein the grid has a non-uniform spacing.

17. The computer program product of claim 14, further comprising:
implementing a sorting algorithm to rank grid points by the magnitude of their associated weights; and
determining the centroids of clusters based on the sorting.

18. The computer program product according to claim 14, further comprising repeating the method based by forming the grid with a finer spacing to more accurately determine the clusters.

19. The computer program product according to claim 17, where the sorting algorithm includes:
placing a number of agents on each grid point of the grid;
applying rules for these agents to move on the grid in steps; and
determining grid points with the highest associated value based on the position of each of the agents after at least one step.

20. The computer program product according to claim 9, wherein the agents are placed randomly on the grid.
